(19) United States
(12) Patent Application Publication
(10) Pub. No.: US 2026/0362575 A1
(43) Pub. Date: Nov. 12, 2026

(54) DYNAMIC MESSAGE BOARD AND LIGHTING DEVICE CONTROLLER AND METHOD FOR CONTROL

(71) Applicant: Actus Manufacturing Inc., St. Paul, MN (US)

(72) Inventors: Pierce Jensen, St. Paul, MN (US); Robby Nicholson, St. Paul, MN (US); Adam Nicholson, St. Paul, MN (US)

(21) Appl. No.: 19/309,038

(22) Filed: Aug. 25, 2025

Related U.S. Application Data
(63) Continuation-in-part of application No. 19/205,267, filed on May 12, 2025.

(51) Int. Cl. H05B 47/175; F21V 23/04; G05G 5/03

(52) U.S. Cl. CPC H05B 47/196; F21V 23/0485; G05G 5/03; G05G 2505/00

(57) ABSTRACT

A system for configuring a lighting device, applicable in vehicular and stationary settings, is disclosed. The system comprises a lighting device capable of displaying messages and flashing lights, which may be mounted on vehicles such as pickup trucks and emergency vehicles. Control is facilitated via a handheld rotational dial mechanism, featuring an outer rotatable wheel with bevels or ridges for grip, haptic detents for tactile feedback, and a centrally located full-color touch screen. The dial allows for message and lighting control through rotation and touch input, with secondary confirmation and security lockout features. The system supports wireless connectivity, enabling control of multiple message boards, and includes user notification and speech recognition capabilities. Customization options are provided for message and flasher control, duration, creation, editing, color, and brightness.

### RELATED APPLICATIONS

The present application claims priority to and incorporates by reference United States Patent App. No. 19/205,267, which was filed on May 12, 2025, and which claims priority to United States Provisional Patent No. 63/564,146 which was filed on Mar. 12, 2024. The present application is a Continuation-in-Part of U.S. Pat. App. No. 19/205,267.

### BACKGROUND OF THE INVENTION

### Field of the Invention

The present invention relates to a method and apparatus for controlling the operation of a lighting device, light bar or message board. In particular, the invention relates to a hand-operated controller to control the operation, configuration, and display of a lighting device located on or in a vehicle or as used in a road based environment or vehicle advisory capacity.

### Background

Message boards and light bars are well known in the prior art. Light bars are often mounted to a high point of a vehicle to provide additional lighting in a variety of circumstances. Message boards are electronic signs that display messages of various types and are commonly mounted on a vehicle for example in the bed of a truck, on the bumper, or any other high visibility location. The messages board can display messages such as directional arrows, text, flashing lights, colored lights, and the like.

Message boards and light bars are used with a wide variety of vehicles. Ambulances, police cars, and fire trucks use light bars to alert traffic of their presence and to clear the road so they can get to their destination faster. Also, the light bars are used after they arrive to make their presence at that location known for safety purposes. Services vehicles do the same such as street sweepers, snowplows, construction vehicles, school buses, delivery trucks, painting trucks, pumpers, mail delivery vehicles, and the like. Light bars are also used by off-road vehicles.

Message boards and light bars are electronic devices that are under computer control. Typically, the controls are inside the vehicle, along with a myriad of other controls and devices. The Message boards and light bars have to a particular setting using a controller, and the settings change as the operation the vehicle changes, which requires accessing the control mechanism repeatedly. This is not always fast, easy or convenient. The operator might have gloves on, be engaged in other activities such as operating equipment or directing traffic, or the operators might be outside the vehicle for other reasons making changes difficult. Also, in the case of emergency responders any distraction that takes them away from their primary tasks is undesirable at best and dangerous or life threatening at worst.

Thus, a need exists for a method and apparatus to more efficiently configure a message board or light bar that does not suffer from the drawbacks associated with the prior art.

### BRIEF DESCRIPTIONS OF THE FIGURES

FIG. 1 is a front view of a rotational dial control for a message board.

FIG. 2 is a further front view of the rotational dial control with an integrated touch-sensitive interface.

FIG. 3 is another front view of parallel rotational dial controls for setting or modifying messages to be displayed.

FIG. 4 is another front view of a touch-sensitive rotational dial control interface.

FIG. 5 is another front view of a touch-sensitive rotational dial control interface.

FIG. 6 is another front view of a touch-sensitive rotational dial control interface with a diagrammatic representation of an audible or readable message confirmation.

FIG. 7 is a diagram showing a wireless or wired connection between a touch-sensitive rotational dial control and a message board.

FIG. 8 is a front view of a touch-sensitive control interface.

FIG. 9 is a flowchart illustrating the software and user interaction logic, including initiation, twist interaction, swipe interaction, recall of messages, and mode switching.

FIG. 10 is another view of a touch-sensitive rotational dial control interface.

FIG. 11 is another view of a touch-sensitive rotational dial control interface.

### DETAILED DESCRIPTION OF THE PREFERRED EMBODIMENTS

In the Figures, a method and apparatus is shown for easily configuring a lighting device, especially in a setting where the message board or lighting device are mounted on a vehicle.

Lighting devices (including message boards and light bars, and the like) typically mount to a vehicle, although the lighting device could be disposed in a stationary application without departing from the scope of the present invention. For example, the lighting device could be mounted on the back of the bed of a pickup truck, atop an emergency vehicle, or on the back of a truck or working vehicle. The device flashes and illuminates and the display can displays either flashes, displays a text message, or a combination of both. The message board can have an LED display, or any other convenient type of displays.

The lighting device is electronically controlled either through a controller hard wired to the device, which typically is mounted in the cab of the vehicle. The controller could be a simple switching device, keyboard, or a computer such as a touch screen device like tablet or mobile device normally located inside the vehicle. Remote software can be used to interface with the controller, such as a SaaS based system. Messages or light patterns can be entered intothe controller through one of the above means, and then the operator can select between preprogrammed display modes using the controller.

As explained above, there is a need to ensure that selection takes place in a fast and convenient minimally distracting manner. Using the controller is not the fastest or most convenient option.

The present invention utilizes as handheld rotational dial mechanism to configure the lighting device. The dial can be hard wired to the sign controller, or can operate remotely through wireless technology such as Wi-Fi or Bluetooth or the like. The dial is disc shaped and comprises an outer rotatable wheel that spins to move between settings. A full color touch screen is located in the center of the dial which when pressed selects and confirms the selected setting. The dial has a screen that displays commands, options, and settings. The wheel has bevels or ridges to make it easy to grip, and includes haptic detents to provide feedback to the user as to when the wheel has been rotated to the next setting. The dial is sized to easily fit in a user’s hand, and can be operated with one or two hands.

The dial can be used to physically move the lighting device between various positions such as a deployed or stowed position, or can tilt up/down or left/right as needed to be visible. The dial can be used to position the lighting device in the manner described above. Generally, the messages or display modes that the dial can select between are pre-configured through the controller, tablet, or a SaaS application and the dial is used as a selection device, however, the invention is not necessary so limited.

Further, multiple dials can be used. A dial can be placed in the cab of a vehicle, and others placed outside the vehicle for ease of access, or the dials can be connected to work in concert with each other.

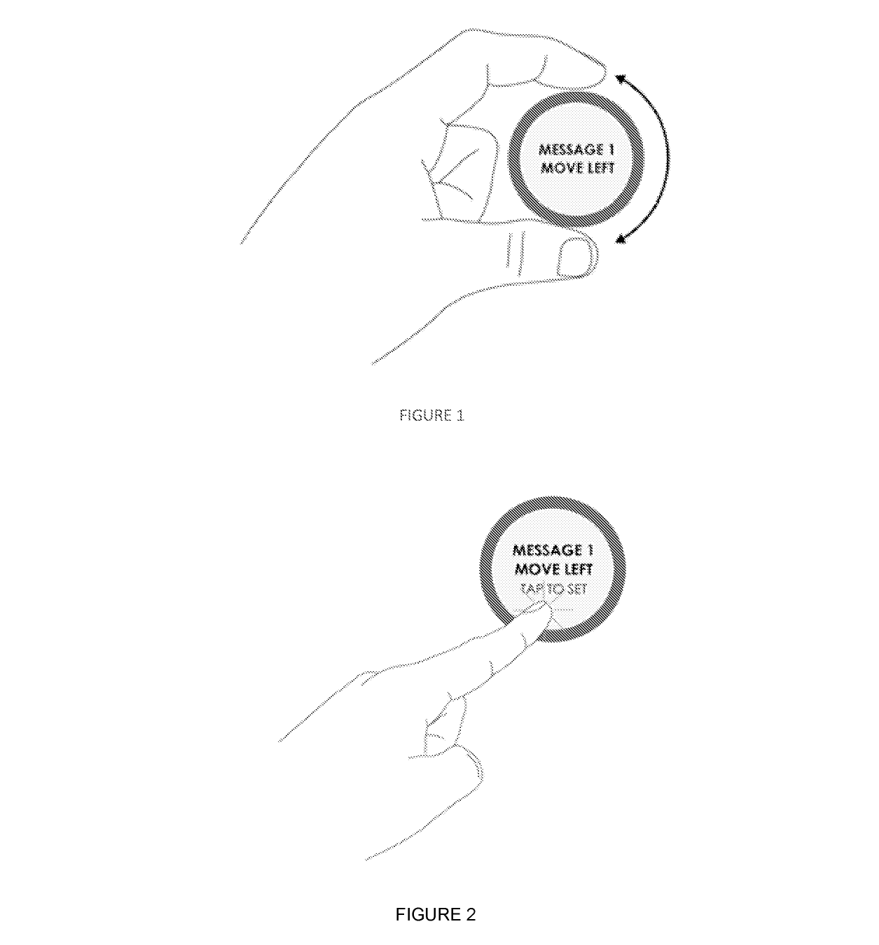

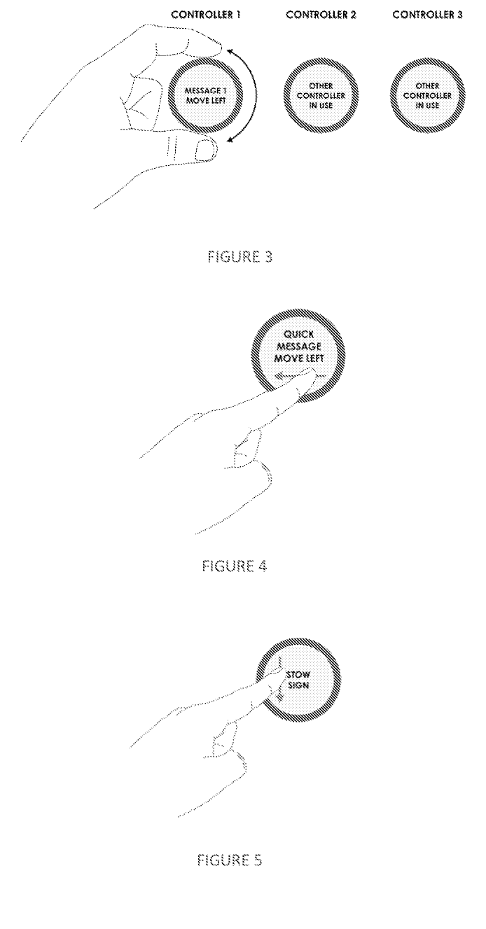

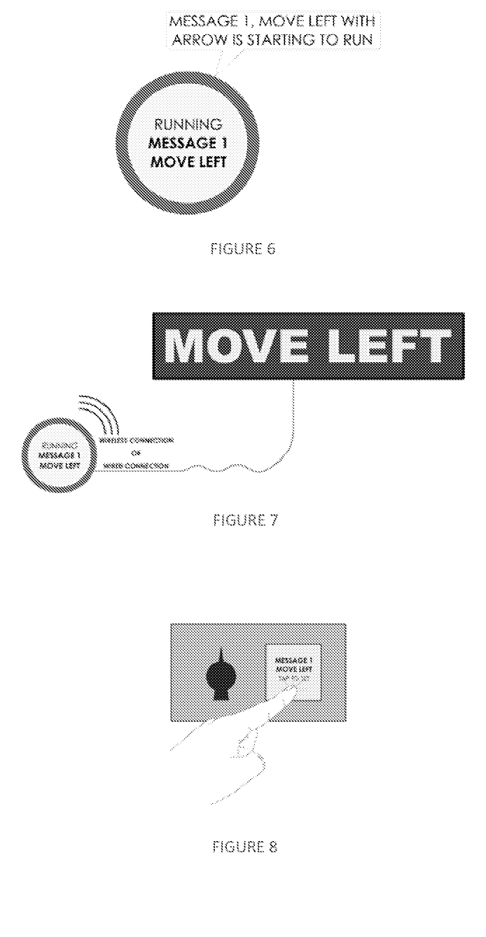

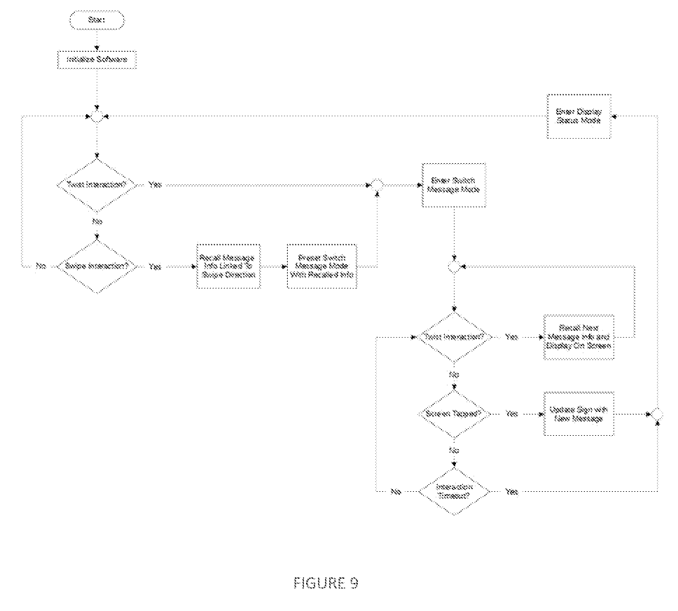

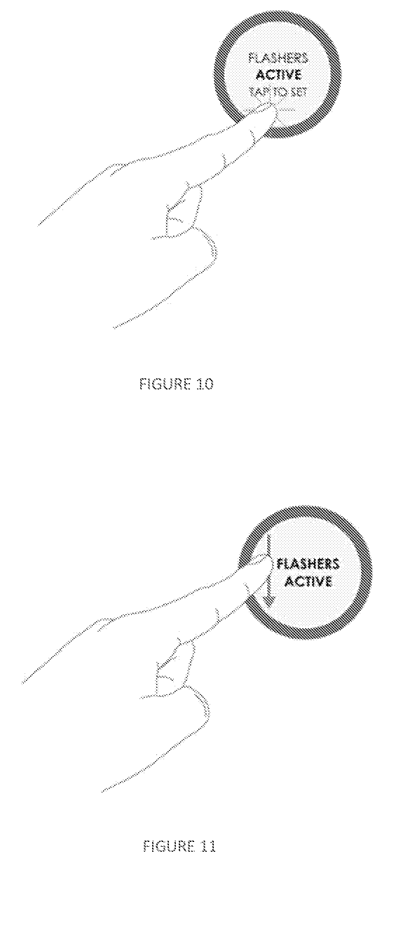

The dial has the following attributes, features, and operation characteristics.
1)Change a message board/emergency lighting device with a rotational dial (FIG. 1/8)
   a) The rotation of the dial works as an input to electrically activate a lighting device whereas the sign display messages will change upon the rotation of a rotary dial.
   b) The rotation of the dial works as an input to electrically activate emergency/non-emergency lighting device whereas lighting device flasher patterns will change upon the rotation of a dial.
   c) The rotation of the dial works as an input to a lighting device with an integrated message board that electrically activates the sign display and/or the lighting device flashers of an emergency/non-emergency lighting device whereas the sign display message and the lighting device flasher patterns will change upon the rotation of a dial.
2) Control message board/emergency lighting device with mechanical ring and an integrated touch screen inside the dial (FIG. 1/2)
   i) The rotational dial comprises an outer ring bezel where the inside face of the dial is an integrated full color touch screen input to select the displayed option to be presented on the lighting device. i) The rotational dial comprises an outer ring bezel where the inside face of the dial is an integrated full color touch screen input to select the displayed option to be presented on the lighting device.
3) Swiping to control the sign display (FIG. 4)
   i) The dial comprises a touch screen that allows for use of a tactile swiping motion as in input to interface and control the lighting device where swiping can cause a change to happen to the display of the device. These swiping motions can also be configured as “quick keys” where various swiping motions can trigger various events.
4) Swiping to control the sign movement (FIG. 5)
   i) The touch screen allows for tactile swiping motion as in input to interface and control the lighting device where swiping can cause a change to happen to the physical position or orientation of the sign display such as sign movement raising, lowing, deploying, or stowing. These swiping motions can also be configured as “quick keys” where various swiping motions can trigger various events.
5) Swiping to control the lighting device flashers (FIG. 10/11)
   i) Using a touch screen tactile swiping motion as in input to an emergency/non-emergency lighting device, or lighting device, where swiping can cause a change to happen to the flashing status or pattern of the lighting device such as turning flashers on or off, changing of the flash pattern, or on/off control of takedown or work lights. These swiping motions can also be configured to trigger various events.
6) After dial rotation confirmation click required (FIG. 2)
   i) The rotation dial can provide an input to electrically control a device and the dial reaching the desired output, and where a secondary confirmation is required via a touch input on a touch screen before action is executed.
7) Optional Security Lockout
   i) After a period of inactivity, the dial prevents actions from being taken until a password or passcode is entered via an onscreen touch keyboard or keypad, or rotational input from the dial, or combination of either.
8) Safety timeout when not knob not touched (FIG. 9)
   i) The rotation of the dial can provide input to electrically control a device and upon the rotation reaching the desired output, a secondary confirmation is required via a touch input on a touch screen. If there is no secondary confirmation the output action will not happen.
9) Endless menu when you rotate dial (FIG. 1)
   i) The rotation dial can provide an input to electrically control a device and upon the rotation reaching the desired output. The rotation dial has no end stop either physically or in software. Upon reaching the end of potential selections, the next selection will loop to the first selection.
10) Can control a sign with multiple dial inputs (FIG. 3)
   i) More than one rotational dial can be connected to provide input to one or more lighting devices. You can select a dial as a primary / secondary or you can select no primary / secondary. Each rotational dial is in sync with the other dials. A priority schedule is used to allow interaction with only one dial at a time, preventing multiple inputs from occurring.
11) Dial can wirelessly connect locally to the sign (FIG. 7)
   a) A rotational dial may be hardwired or wirelessly connected to the lighting device via 802.X, Bluetooth, LoRA, cellular, etc.
   b) Wireless communication may be used to control multiple message boards in the localized area.
12) Displaying connection data
   a) The screen of the rotational dial is able to display preset or custom created QR codes to allow for 3rd party QR code reader devices to connect to the system via wireless control.
   b) The screen is able capable of displaying wireless network connectivity information including, but not limited to, network name, username, password and URL info.
   c) This connectivity information can be turned off in a user configuration setting if that information is not wanted to be accessible to the user.
13) Audible tones, lights, or text to speech can be used to notify user of sign message display (FIG. 6)
   i) Current status of the lighting device can notify the user using audible tones, lights, or text to speech algorithms.
14) Speech control
   i) The dial can optionally use speech recognition technology to activate the message board or emergency lights.
15) Configuration of a lighting device
i) The rotary dial and touch screen will allow for customization and configuration of all variables present in the controlled device, including:
   (a) Messaging control, message on/off duration, message creation, message editing, messaging color, messaging brightness, flasher control, flasher on/off duration, flash pattern creation, flash pattern editing, flasher color, flasher brightness.

The present invention completely or substantially solves the problems in the prior art by providing a convenient, efficient, safe, and fast method and apparatus to configure a lighting device. The device eliminates the need for prior art controllers, devices, switches, and the like thereby allowing the operators to stay focused on their main task or goal.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A system for configuring a lighting device, comprising:
a lighting device configured to be mounted on an object, the lighting device comprising a display capable of presenting messages and flashing lights;
a rotational dial mechanism operatively connected to the lighting device, the dial mechanism comprising: an outer rotatable wheel; device for providing tactile feedback during operation; a full-color touch screen for selection and confirmation of settings;
wherein the rotation of the dial serves as an input to change the message displayed or alter the patterns of the lighting device;
wherein the touch screen allows for tactile swiping motions to control the lighting device, including changing the display, physical position, or orientation of the sign, and the flashing status or pattern;
a secondary confirmation feature requiring touch input after dial rotation to execute actions;
a security lockout feature requiring a password or passcode after a period of inactivity;
an endless menu allowing continuous rotation of the dial without physical or software end stops;
wireless connectivity enabling the dial to connect to the lighting device using communication protocols, and control multiple message boards within a localized area;
user notification features providing status updates through audible tones, lights, or text-to-speech;
speech recognition technology for activating the message board or lights;
customization features allowing for message and flasher control, duration, creation, editing, color, and brightness adjustments.

2. The system of claim 1, wherein the dial mechanism is hardwired to the lighting device's controller.

3. The system of claim 1, wherein the dial mechanism operates wirelessly through Wi-Fi, Bluetooth, or similar technologies.

4. The system of claim 1, further comprising multiple dials used in concert, with a priority schedule to manage inputs.

5. The system of claim 1, wherein the touch screen displays connectivity information and QR codes for third-party device integration.

6. The system of claim 1 where the object is a vehicle.

7. The system of claim 1 where the dial mechanism is handheld.

8. The system of claim 1 where rotatable wheel has bevels and ridges for grip.

9. The system of claim 1 where the device for providing tactile feedback has haptic detents.
